(19) United States
(12) Patent Application Publication
(10) Pub. No.: US 2022/0210294 A1
(43) Pub. Date: Jun. 30, 2022

(54) SOFTWARE-IMPLEMENTED GENLOCK AND FRAMELOCK

(71) Applicant: ATI TECHNOLOGIES ULC, Markham (CA)

(72) Inventor: David I. J. GLEN, Markham (CA)

(21) Appl. No.: 17/138,181

(22) Filed: Dec. 30, 2020

(51) Int. Cl. H04N 5/04; H03L 7/099

(52) U.S. Cl. CPC H04N 5/04; H03L 7/099

(57) ABSTRACT

A processing system synchronizes the frequencies and phases of the display outputs of multiple video processing units (VPUs) by adjusting a local time base generated at each VPU to match a virtual global time base generated based on a network protocol and to synchronize video timing for the display outputs based on the virtual global time base.

### BACKGROUND

Applications that require synchronized display output from multiple processors typically employ dedicated hardware and cabling to connect to each other and to an external reference (“house sync”) signal that generates a common time base for the processors to lock frequency (generation lock, or “Genlock”) and phase (“Framelock”) of display module refresh rates. For example, display walls that are used in advertising and in television and film production include an array of display modules (also frequently referred to as “display panels”), each of which displays a portion of a frame, such that the display modules of the array together display a complete frame and produce a larger viewing area than any single display panel. Large display walls including more than four display modules are typically driven by multiple video processing units that must be locked in frequency and phase in order to avoid visual problems with motion or image tearing.

### BRIEF DESCRIPTION OF THE DRAWINGS

The present disclosure is better understood, and its numerous features and advantages made apparent to those skilled in the art by referencing the accompanying drawings. The use of the same reference symbols in different drawings indicates similar or identical items.

FIG. 1 is a block diagram of a processing system including a plurality of video processing units dynamically synchronizing display of frames of video at a plurality of display modules in accordance with some embodiments.

FIG. 2 is block diagram of a display timing generator of a video processing unit for synchronizing a local time base frequency to a virtual global time base frequency in accordance with some embodiments.

FIG. 3 is a flow diagram illustrating a method for performing a “mode set” to synchronize a local time base frequency to a virtual global time base frequency in accordance with some embodiments.

### DETAILED DESCRIPTION

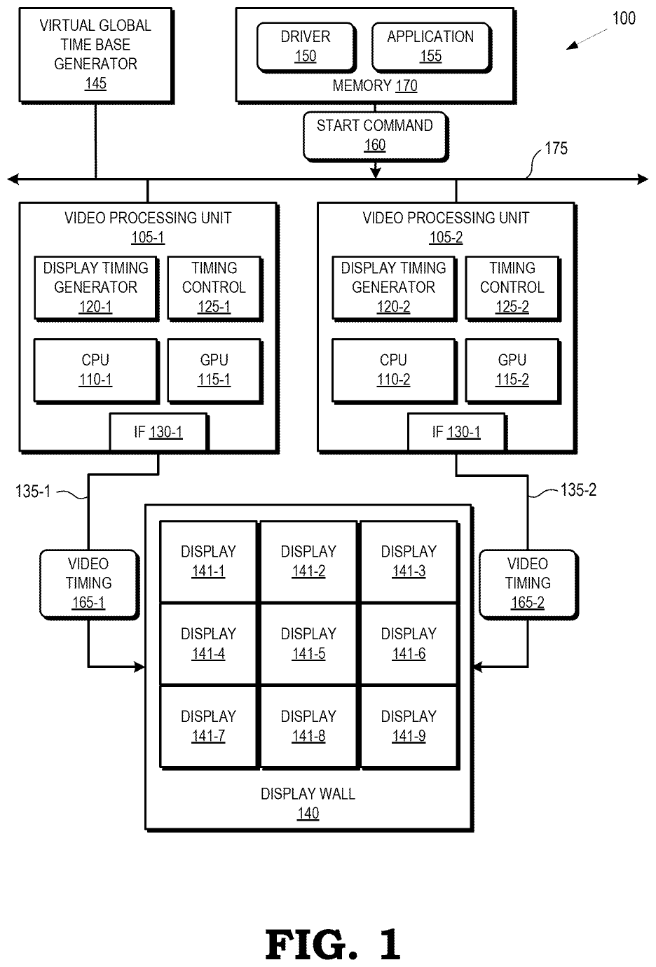

FIGS. 1-3 illustrate systems and techniques for synchronizing the frequencies and phases of the display outputs of multiple video processing units (VPUs) by adjusting a local time base generated at each VPU to match a virtual global time base generated based on a network protocol and synchronizing a start time for the display outputs based on the virtual global time base. In some embodiments, such as large display walls incorporating a large number of display modules, a processing system includes multiple VPUs that each drive multiple display modules, with each VPU generating a portion of a frame for display at each of the multiple display modules. Each display module displays a portion of the frame such that the display modules of the array together display the full frame.

The VPUs of the processing system include software to generate a virtual global time base using a network protocol such as IEEE 1588 Precision Time Protocol (PTP), which employs a master/slave architecture to maintain synchronization across all system components. For example, in the IEEE 1588 network protocol, a PTP master clock serves as a reference source that provides time-stamped messages to components (PTP slaves) of the system. The PTP slaves then synchronize to the PTP master timing reference by comparing their local time references to the timestamps in the received messages. In this manner, the VPUs virtually create a global time base without reference to a physical clock signal.

Each VPU also includes a display timing generator that generates video timing produced from a local reference clock (referred to as a local time base) for the VPU. Each VPU performs a “mode set” by comparing the frequency of the local time base to the frequency of the virtual global time base that was generated based on the network protocol and adjusting the local time base to match the frequency of the virtual global time base. In some embodiments, the adjustments are kept within a threshold amount, such as +/−30 ppm, so as not to disrupt the display modules. The mode set locks the frequency of the local time base to the frequency of the virtual global time base.

In some embodiments, the VPU display timing generator generates the local time base using a phase locked loop (PLL) and frequency divider in conjunction with a clock source such as a crystal oscillator. The VPU display timing generator includes settings for generating a number of discrete frequencies that are a function of a base clock signal produced by the clock source. In some embodiments, the frequency differences between settings are larger than the amount by which the local time base must be adjusted to match the frequency of the virtual time base. To perform a mode set in which the adjustment is between settings, the VPU display timing generator determines a ratio of two adjacent settings to reach an average target frequency. For example, in some embodiments, if the virtual global time base is slightly slower than a “normal” setting of the local time base, the VPU display time generator selects a slower frequency setting for 10% of the time and selects the normal frequency setting for 90% of the time.

Once the mode set has been performed and the refresh rates of the VPUs and their corresponding display modules have been locked, the processing system synchronizes the phases of the VPU refresh rates by signaling all of the VPU display timing generators to start at the same time with respect to the virtual global time base. In response, the VPUs issue simultaneous (or near simultaneous) vertical sync (vsync) commands and other fixed refresh rate video timing signals to their respective display modules. Once the frequencies of the VPUs have been fixed during the mode set, the phases of the VPUs are maintained in synchronicity by keeping the frequencies locked. To prevent the frequencies of the VPU local time bases from drifting over time due to factors such as heat, each VPU periodically monitors differences between the local time base and the virtual global time base and adjusts the local time base as needed to match the rate of the virtual global time base.

As used herein, “synchronized” or “simultaneous” refers to a relative alignment, within a specified amount of time (an error margin), of a specific point in display cycles of two or more display modules. For example, in some embodiments, two or more display modules are considered “synchronized” if they begin vertical active periods within a specified amount of time of each other, even if other points in the respective display cycles, such as a beginning of respective vertical blanking periods, are not begun within the specified amount of time of each other, and even if other display cycles, such as every other display cycle for one of the display modules, are not begun within the specified amount of time of each other.

FIG. 1 illustrates a processing system 100 including a plurality of video processing units (VPUs) 105 (such as the illustrated VPUs 105-1, 105-2) dynamically synchronizing display of frames of video at a plurality of fixed refresh rate display modules 141 (such as the illustrated display modules 141-1, 141-2, 141-3, 141-4, 141-5, 141-6, 141-7, 141-8, 141-9) of a display wall 140 in accordance with some embodiments. The processing system 100 is generally configured to execute sets of instructions (e.g., computer programs) such as application 155 to carry out specified tasks for an electronic device. Examples of such tasks include controlling aspects of the operation of the electronic device, displaying information to a user to provide a specified user experience, communicating with other electronic devices, and the like. Accordingly, in different embodiments the processing system 100 is employed in one of a number of types of electronic device, such as a desktop computer, laptop computer, server, game console, and the like. It should be appreciated that processing system 100 may include more or fewer components than illustrated in FIG. 1. For example, processing system 100 may additionally include additional VPUs, one or more input interfaces, non-volatile storage, one or more output interfaces, network interfaces, and more or fewer fixed refresh rate display modules or display interfaces.

As illustrated in FIG. 1, the processing system 100 also includes a memory 170, an operating system (not shown), a communications infrastructure 175, and one or more applications 155. Access to memory 170 is managed by a memory controller (not shown), which is coupled to memory 170. For example, requests from the VPUs 105 or other devices for reading from or for writing to memory 170 are managed by the memory controller. In some embodiments, the one or more applications 155 include various programs or commands to perform computations that are also executed at the VPUs 105. The processing system 100 further includes a driver 150. Components of processing system 100 may be implemented as hardware, firmware, software, or any combination thereof.

Within the processing system 100, the memory 170 includes non-persistent memory, such as DRAM (not shown). In various embodiments, the memory 170 stores processing logic instructions, constant values, variable values during execution of portions of applications or other processing logic, or other desired information. For example, parts of control logic to perform one or more operations on VPUs 105 reside within memory 170 during execution of the respective portions of the operation by VPUs 105. During execution, respective applications, operating system functions, processing logic commands, and system software reside in memory 170. In some embodiments, other software commands (e.g., driver 150) also reside in memory 170 during execution of processing system 100.

The software driver 150 receives graphics operations from the application 155 and converts the graphics operations into a command stream that is provided to a graphics pipeline of the processing system 100. Driver 150 is a computer program that allows a higher-level graphics computing program, such as from application 155, to interact with VPUs 105-1, 105-2. For example, driver 150 translates standard code received from application 155 into a native format command stream understood by VPUs 105-1, 105-2. Driver 150 allows input from application 155 to direct settings of each VPU 105. Such settings include timing of starting a local time base after a mode set.

To support execution of the sets of instructions, the VPUs 105-1, 105-2 each includes at least one memory (not shown), a display timing generator 120-1, 120-2, at least one processor, such as a central processing unit (CPU) 110-1, 110-2, and a display interface (IF) 130-1, 130-2. The interfaces 130-1, 130-2 include wired or wireless interconnect interfaces, such as HDMI interfaces, DisplayPort interfaces, embedded DisplayPort (eDP) interfaces, and the like.

In some embodiments, each CPU 110-1, 110-2 includes one or more instruction pipelines to fetch instructions, decode the instructions into corresponding operations, dispatch the operations to one or more execution units, execute the operations, and retire the operations. In the course of executing instructions, the processors generate graphics operations and other operations associated with the visual display of information. Based on these operations, the processors provide commands and data to one or more parallel processors, such as graphics processing units (GPUs) 115-1, 115-2. The techniques described herein are, in different embodiments, employed at any of a variety of parallel processors (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like). FIG. 1 illustrates an example of a parallel processor and, in particular, GPUs 115-1, 115-2, in accordance with some embodiments.

The GPUs 115-1, 115-2 are generally configured to receive the commands and data associated with graphics and other display operations from the CPUs 110-1, 110-2. Based on the received commands, the GPUs 115-1, 115-2 execute operations to generate images (frames) for display. Examples of operations include vector operations, drawing operations, and the like. The rate at which the GPUs 115-1, 115-2 are able to generate frames based on these operations is referred to as the frame generation rate, or simply the frame rate, of the GPUs 115-1, 115-2.

In some embodiments, the GPUs 115-1, 115-2 employ multiple buffering for outputting respective portions of frames to the display modules 141, such that the GPU 115-1, 115-2 is writing a frame to one buffer (referred to as the back buffer) while a current frame is being scanned out from another buffer (referred to as the front buffer). At a fixed frequency referred to as the refresh rate, the GPU 115-1, 115-2 “flips” the buffer that is being scanned out to the display such that the buffer that had been the back buffer is now the front buffer (i.e., the scan out buffer), and the buffer that had previously been the scan out buffer is now the back buffer (i.e., the buffer to which the GPU 115-1, 115-2 writes).

The display timing generators 120-1, 120-2 generate one or more clock signals to synchronize logic operations at the VPUs 105-1, 105-2. The timing control modules 125-1, 125-2 set the frequencies for the clock signals generated by the display timing generators 120-1, 120-2. The display timing generators 120-1, 120-2 are configured to receive a set of signals from the timing control modules 125-1, 125-2 and a set of base clock signals generated by a phase locked loop (PLL) based on a reference clock signal (not shown) from a crystal oscillator (not shown). The display timing generators 120-1, 120-2 combine the base signals to generate a clock signal at a frequency indicated by the received signals from the timing control modules 125-1, 125-2, referred to as the local time base. The display timing generators 120-1, 120-2 and the timing control modules 125-1, 125-2 are implemented as hard-coded or programmable logic, one or more processors executing software/firmware instructions, or any combination thereof.

The display wall 140 includes an array of display modules 141-1, 141-2, 141-3, 141-4, 141-5, 141-6, 141-7, 141-8, 141-9 (collectively referred to as display modules 141). Each display module 141 receives portions of rendered frames from one of the VPUs 105-1, 105-2. For example, in some embodiments, VPU 105-1 generates portions of rendered frames and outputs one portion to each of display modules 141-1, 141-2, 141-3, 141-4, while VPU 105-2 generates portions of rendered frames and outputs one portion to each of display modules 141-5, 141-6, 141-7, 141-8, 141-9 such that when each of the display modules 141 displays its received rendered portions of a frame, the entire frame (image) is displayed across all of the display modules 141 of the display wall 140. Each display module 141 includes a display panel and synchronizes refreshing the display panel with the local time base of the VPU 105-1, 105-2 from which the display module 141 receives rendered frames.

As a general operational overview, the CPUs 110-1, 110-2 and GPUs 115-1, 115-2 generate a video stream including a series of display frames and corresponding metadata and transmit this video stream to the display modules 141 via the display interfaces 130-1, 130-2 and interconnects 135-1, 135-2. At each of the display modules 141, a display controller (not shown) receives each display frame and corresponding metadata in turn and processes the display frame for display in sequence at display panels of the display modules 141 during a corresponding frame period. As will be appreciated by one skilled in the art, the display modules 141 are generally configured to display the most recent frame generated by the corresponding GPUs 115-1, 115-2 by refreshing the display panels using the pixel data that the display modules 141 receive from the corresponding GPUs 115-1, 115-2.

Each frame generated by the GPUs 115-1, 115-2 includes a vertical active region and a vertical blanking region. The vertical active region includes pixel data that make up the image to be displayed at the display panels of the display modules 141. The vertical blanking region includes metadata such as information indicating how the display modules 141 are to interpret the pixel data. During the period of time in which the display controllers receive the vertical blanking region (referred to as the vertical blanking interval), in some embodiments, the display panels display the image that was last transmitted by the GPUs 115-1, 115-2 in the previous vertical active region.

To facilitate the synchronization of the display of images by each of the display modules 141 of the display wall 140, the processing system 100 uses a software process to frequency and phase align all of the display modules 141 to within a threshold number of display line periods without additional hardware such as a house sync receiver or coaxial cables to interconnect the VPUs 105-1, 105-2. The processing system includes a virtual global time base generator 145 to generate a network protocol-based virtual global time base for the VPUs 105-1, 105-2. The virtual global time base generator 145 is implemented as hard-coded or programmable logic, one or more processors executing software/firmware instructions, or any combination thereof. In some embodiments, the virtual global time base generator 145 is incorporated in the VPUs 105-1, 105-2. In some embodiments, the virtual global time base generator 145 serves as the PTP master clock signal. In other embodiments, the virtual global time base generator 145 selects a clock signal generated by another networked component as the PTP master clock signal.

Using a network protocol, such as PTP, Reference Broadcast Time Synchronization (RBS), Reference Broadcast Infrastructure Synchronization (RBIS), Synchronous Ethernet, IEEE 802.1 Time-Sensitive Networking, or SMPTE 2059, the virtual global time base generator 145 distributes a common virtual global time base that is based on a network time base to devices of the processing system 100 without the need for cable-based distribution of a house sync or common reference clock to all devices.

Each VPU 105-1, 105-2 performs a “mode set” to lock the frequency of the local time base to the frequency of the virtual global time base. To perform the mode set, the VPUs 105-1, 105-2 each compare the frequency of their corresponding local time base and the virtual global time base. The VPUs 105-1, 105-2 monitor the difference between their respective local time bases and the virtual global time base and adjust the local time bases to match the frequency of the virtual global time base. Thus, if the virtual global time base is faster than a local time base, the VPU increases the frequency of the local time base. Conversely, if the virtual global time base is slower than the local time base, the VPU decreases the frequency of the local time base.

After the mode set has been completed and the local time bases have been synchronized with the virtual global time base, the display timing generators 120-1, 120-2 signal the driver 150 to indicate that the display timing generators 120-1, 120-2 have adjusted the frequencies of their local time bases to match the frequency of the virtual global time base. In response to receiving the indication that the frequencies of the local time bases match the frequency of the virtual global time base, the driver 150 transmits a start command to the VPU display timing generators 120-1, 120-2 to start at the same time on the virtual global time base. In response to receiving the start command, the VPUs 105-1, 105-2 send fixed refresh rate video timing signals, including information such as a vertical synchronization (vsync) command, fixed refresh rate, line rate, and pixel clock timing, to the display modules 141 via the display interfaces 130-1, 130-2 and interconnects 135-1, 135-2 at the time indicated by the start command. The video timing signals indicate the start of a display cycle for displaying the generated portions of the frame. Simultaneous (or near simultaneous) issuance of the video timing signals 165-1, 165-2 by the VPUs 105-1, 105-2 effectively synchronizes the frequencies and phases of the display cycles of each of the display modules 141 based on the virtual global time base to within a few display line periods, which is a difference that is not perceptible by the human eye.

Once the VPU display timing generators 120-1, 120-2 start at the same time on the virtual global time base with frequencies that match the frequency of the virtual global time base, the VPU display timing generators 120-1, 120-2 remain essentially locked in both frequency and phase with each other. The VPUs 105-1, 105-2 generate new frames at the frequency of the virtual global time base and the display modules 141 refresh at the same rate, within a small margin such as a few line periods. Over time, it is possible that the frequency of the local time base of one or more of the VPUs 105-1, 105-2 will drift and become faster or slower than the virtual global time base due to factors such as heat. To maintain synchronicity over time, the display timing generators 120-1, 120-2 monitor differences between the frequencies of the local time base and the virtual global time base and re-adjust the local time base frequency to match the virtual global time base if the difference exceeds a threshold.

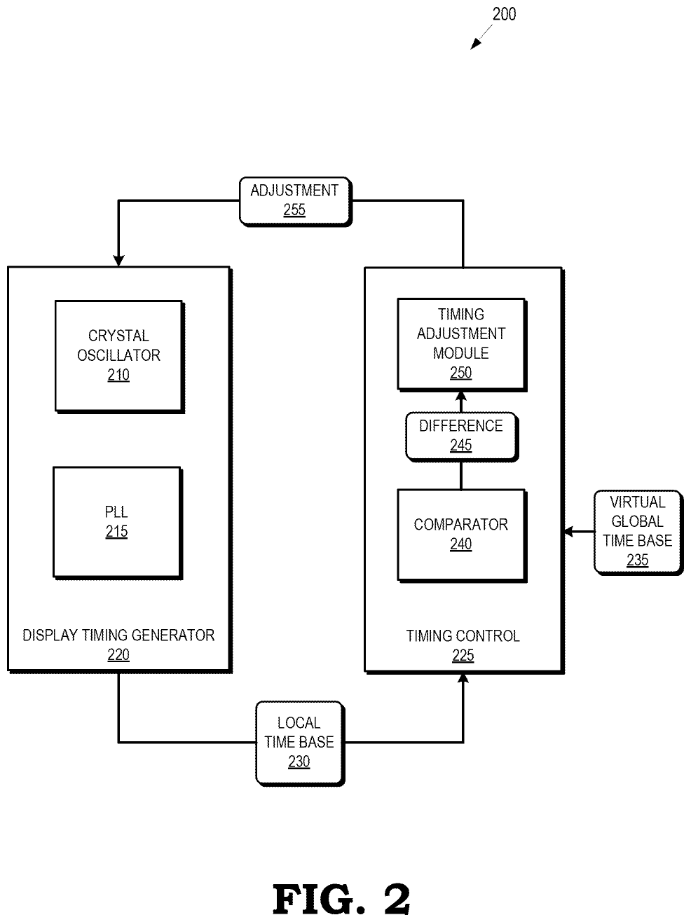

FIG. 2 is block diagram 200 of a display timing generator 220 of a VPU 105-1, 105-2 and a timing control 225 for synchronizing a local time base frequency to a virtual global time base frequency in accordance with some embodiments. The display timing generator 220 includes a PLL 215 that receives a reference clock signal from a crystal oscillator 210 or other clock source and based on the reference clock signal generates a plurality of base clock signals. The display timing generator 220 combines the base clock signals to generate a local time base 230 at a frequency indicated by signal received from the timing control 225.

The timing control 225 includes a comparator 240 and a timing adjustment module 250. The comparator 240 receives a clock signal of the local time base 230 and a clock signal of the virtual global time base 235 and compares the frequencies of the two clock signals. If the comparator detects a difference 245 between the frequencies, the comparator indicates the difference 245 to the timing adjustment module 250. The timing adjustment module 250 determines an adjustment 255 to be applied to the frequency of the local time base 230 that will bring the local time base 230 into synchronicity with the virtual global time base 235. For example, if the comparator 240 determines that the difference 245 between the local time base 230 frequency and the virtual global time base frequency 235 is −10 ppm (i.e., the local time base is 10 parts per million slower than the virtual global time base), the timing adjustment module 250 indicates an adjustment 255 of +10 ppm for the local time base 230 frequency.

In some embodiments, the display timing generator 220 is capable of generating clock signals in discrete increments (settings) that are greater than the value of the difference 245 in frequencies detected by the comparator 240. For example, if the difference 245 is −10 ppm and the next-slowest clock frequency setting is −30 ppm, the timing adjustment module 250 indicates an adjustment 255 that selects the next-slowest frequency setting for a fractional portion of a time period, or epoch, an selects the initial frequency setting for the remainder of the epoch such that the average frequency over the course of the epoch equals the frequency of the virtual global time base 235.

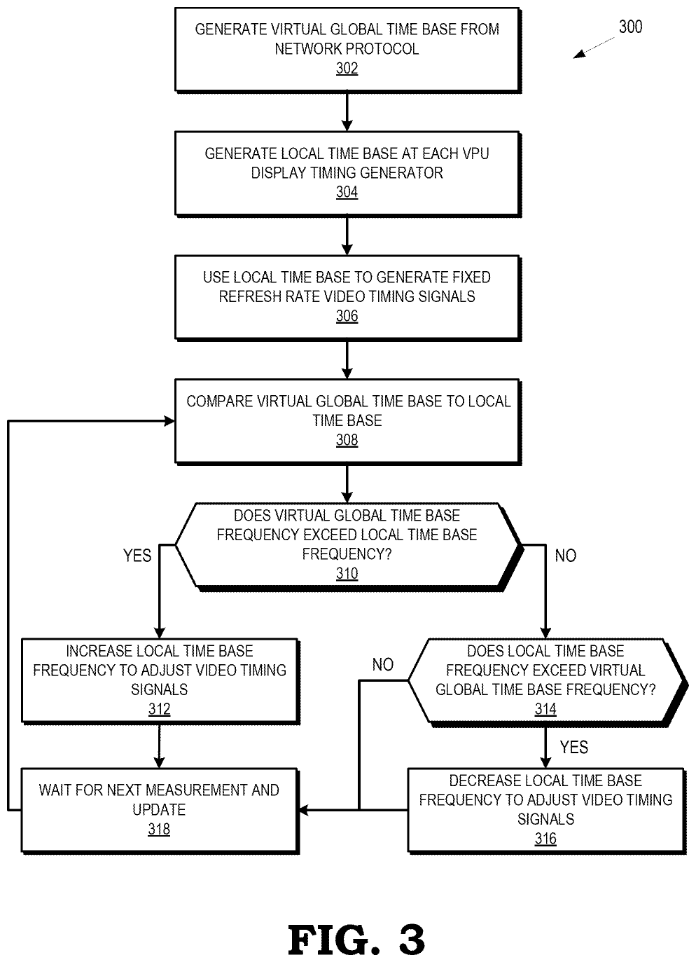

FIG. 3 is a flow diagram illustrating a method 300 for performing a mode set by synchronizing a local time base frequency of a plurality of VPUs 105-1, 105-2 to a virtual global time base frequency in accordance with some embodiments. Method 300 is implemented in a processing system such as processing system 100 of FIG. 1. In some embodiments, method 300 is initiated by one or more processors in response to one or more instructions stored by a computer-readable storage medium.

At block 302, the virtual global time base generator 145 generates a virtual global time base from a network protocol such as PTP. At block 304, each of the VPU display timing generators 120-1, 120-2 generates a local time base. At block 306, the VPUs 105-1, 105-2 use the local time base frequency to generate fixed refresh rate video timing signals for each of the display modules 141 for which the VPUs 105-1, 105-2 generate frames or portions of frames for display. By issuing the video timing signals 165-1, 165-2 at the same time in the virtual global time base, VPUs 105-1, 105-2 effectively synchronize the frequencies and phases of the display cycles of each of the display modules 141 based on the virtual global time base to within a few display line periods.

At block 308, the timing control modules 125-1, 125-2 compare the virtual global time base frequency to the local time base frequency of their respective VPUs 105-1, 105-2. At block 310, the timing control modules 125-1, 125-2 determine if the virtual global time base frequency exceeds the local time base frequency. In some embodiments, the timing control modules 125-1, 125-2 determine if the frequencies of the local time bases have drifted far enough from the virtual global time base frequency to cause the displays to be more than a threshold amount (such as a display line) out of sync. If, at block 310, the timing control modules 125-1, 125-2 determine that the virtual global time base frequency exceeds the local time base frequency of their VPU 105-1, 105-2, the method flow continues to block 312. At block 312, the timing control modules 125-1, 125-2 increase the local time base frequencies to approximately match or slightly exceed the virtual global time base frequency. The method flow then continues to block 318, at which the timing control modules 125-1, 125-2 wait for a predetermined period of time (or number of frames or clock cycles) to make the next frequency measurements and updates so that adjustments to the local time base frequencies are made on a periodic basis. The method flow then continues back to block 308 as the timing control modules 125-1, 125-2 continue to monitor differences between the local time base frequency and the virtual global time base frequency.

If, at block 310, the timing control modules 125-1, 125-2 determine that the virtual global time base frequency does not exceed the local time base frequency of their VPU 105-1, 105-2, the method flow continues to block 314. At block 314, the timing control modules 125-1, 125-2 determine if the local time base frequency exceeds the virtual global time base frequency. If, at block 314, the timing control modules 125-1, 125-2 determine that the local time base frequency does not exceed the virtual global time base frequency, the method flow continues to block 318. If, at block 314, the timing control modules 125-1, 125-2 determine that the local time base frequency exceeds the virtual global time base frequency, the method flow continues to block 316. At block 316, the timing control modules 125-1, 125-2 decrease the local time base frequency to approximately match or be slightly lower than the virtual global time base frequency. The method flow then continues back to block 318 as the timing control modules 125-1, 125-2 continue to monitor differences between the local time base frequency and the virtual global time base frequency on a periodic basis and adjust the local time base frequencies as needed to maintain synchronicity with the virtual global time base and with each other.

In some embodiments, the apparatus and techniques described above are implemented in a system including one or more integrated circuit (IC) devices (also referred to as integrated circuit packages or microchips), such as the processing system described above with reference to FIGS. 1-3. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
generating a virtual global time base, the virtual global time base synchronized to a network time base based on a network protocol, for a plurality of video processing units (VPUs), wherein each VPU generates one or more portions of a frame for display at one or more of a plurality of display modules, the display modules having fixed refresh rates;
generating, at each VPU, a local time base;
monitoring, at each VPU, a difference in frequency between the corresponding local time base and the virtual global time base; and
adjusting a frequency of the local time base based on the difference.

2. The method of claim 1, further comprising:
receiving a signal from each VPU indicating that the VPUs have adjusted the frequency of the local time base based on the difference; and
transmitting a start command to the VPUs to start at the same time on the network time base in response to receiving the signal from each of the VPUs.

3. The method of claim 2, further comprising:
sending, at each VPU, fixed refresh rate video timing signals to the display modules in response to receiving the start command.

4. The method of claim 1, wherein adjusting comprises:
decreasing a frequency of the local time base in response to determining that the local time base is faster than the virtual global time base; and
increasing the frequency of the local time base in response to determining that the local time base is slower than the virtual global time base.

5. The method of claim 1, wherein the local time base for each VPU is based on a crystal oscillator and a phase locked loop (PLL) having a plurality of discrete settings at the VPU.

6. The method of claim 5, wherein adjusting comprises selecting one or more discrete settings of the PLL for one or more portions of a time period based on the difference.

7. The method of claim 1, wherein adjusting comprises adjusting periodically based on the difference exceeding a threshold.

8. A method, comprising:
comparing a frequency of a local time base generated at each of a plurality of video processing units (VPUs) to a frequency of a virtual global time base for the plurality of VPUs generated based on a network protocol; and
in response to determining that the frequency of the local time base differs from the virtual global time base, adjusting the frequency of the local time base to match the frequency of the virtual global time base.

9. The method of claim 8, further comprising:
receiving a signal from each of the VPUs indicating that the VPU has adjusted the frequency of the local time base to match the frequency of the virtual global time base; and
transmitting a start command to the VPUs to start at the same time on the virtual global time base in response to receiving the signal from each of the VPUs.

10. The method of claim 9, further comprising:
sending, at each of the VPUs, fixed refresh rate video timing signals to one or more display modules in response to receiving the start command.

11. The method of claim 8, wherein adjusting comprises:
decreasing the local time base frequency in response to determining that the local time base is faster than the virtual global time base; and
increasing the local time base frequency in response to determining that the local time base is slower than the virtual global time base.

12. The method of claim 8, wherein the local time base for each VPU is based on a crystal oscillator and a phase locked loop (PLL) having a plurality of discrete settings at the VPU.

13. The method of claim 12, wherein adjusting comprises selecting one or more discrete settings of the PLL for one or more portions of an epoch based on an amount by which the frequency of the local time base differs from the virtual global time base.

14. The method of claim 8, wherein adjusting comprises adjusting periodically based on the amount by which the frequency of the local time base differs from the virtual global time base exceeding a threshold.

15. A system, comprising:
a plurality of video processing units (VPUs), each VPU configured to generate images for display at one or more display modules, wherein each VPU comprises a timing generator configured to:
generate a local time base;
compare a frequency of the local time base to a frequency of a virtual global time base for the plurality of VPUs generated based on a network protocol; and
adjust the frequency of the local time base to match the frequency of the virtual global time base in response to determining that the frequency of the local time base differs from the virtual global time base.

16. The system of claim 15, further comprising:
a driver configured to:
receive a signal from each of the VPU display timing generators indicating that the VPU display timing generators have adjusted the frequency of the local time base to match the frequency of the virtual global time base; and
transmit a start command to the VPU display timing generators to start at the same time on the virtual global time base in response to receiving the signal from each of the VPU display timing generators.

17. The system of claim 16, wherein each VPU is configured to:
send fixed refresh rate video timing signals to the display modules in response to receiving the start command.

18. The system of claim 15, wherein each timing generator is configured to:
decrease the local time base frequency in response to determining that the local time base is faster than the virtual global time base; and
increase the local time base frequency in response to determining that the local time base is slower than the virtual global time base.

19. The system of claim 15, wherein the local time base for each VPU is based on a crystal oscillator and a phase locked loop (PLL) having a plurality of discrete settings at the VPU.

20. The system of claim 19, further comprising:
a plurality of display modules having fixed refresh rates configured to receive images for display from the plurality of VPUs.
